(19) United States
(12) Patent Application Publication
(10) Pub. No.: US 2002/0166118 A1
(43) Pub. Date: Nov. 7, 2002

(54) System and method for detecting dirty data fields

(75) Inventors: Gerry Kovan, Thornhill (CA); Patrick S.C. Tiu, Toronto (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 09/995,238

(22) Filed: Nov. 28, 2001

(30) Foreign Application Priority Data
Nov. 30, 2000 (CA) 2327196

(51) Int. Cl. H04N 7/16

(52) U.S. Cl. 725/1

(57) ABSTRACT

The invention relates to a system and method for indicating when changes to values of data fields in a document have occurred. In one embodiment of the invention, two objects are created upon the loading of an HTML form on an HTML page in a web browser. One object stores the initial values of the data in the HTML form, while the other object is subsequently updated so that the current values of the data in the HTML form are stored therein. When the data in the HTML form is submitted to a server, the data in the two objects are compared to determine which data fields of the HTML form are “dirty”; i.e., which data fields have current values different from their initial values. A record identifying which data fields are “dirty” is created and is submitted to the server along with the data in the HTML page.

### FIELD OF THE INVENTION

This invention relates generally to documents and objects having multiple data fields, in which the data in those data fields can be modified by a user. More specifically, this invention relates to a system and method of indicating when changes to the data in those data fields have occurred.

### BACKGROUND OF THE INVENTION

Information in documents or objects capable of accepting input from computing application users can be used for viewing, updating, and creating data, where the data is stored in one or more data storage devices. More specifically, it is common to store data received as input from such users in one or more databases residing on such data storage devices. When changes initiated by application users are to be made to the data through such documents or objects, it is necessary to update the data in the databases to reflect these changes.

Some documents capable of accepting input from computing application users include a single form having multiple data fields. For example, a Hypertext Markup Language (HTML) page which includes an HTML form may be used for the purpose of displaying data to a user through a web browser, and accepting changes to the data as input. Values assigned to those data fields may be retrieved from one or more databases and displayed to the user. The user can then change the data in the HTML page by assigning a new value to certain data fields in the HTML form as specified by the user.

Other documents or objects capable of accepting input from computing application users may have a hierarchical structure, in which the main document or object may consist of several sub-documents or objects. Each sub-document or object may also consist of several sub-documents or objects. A sub-document or object may have multiple data fields. Values assigned to those data fields may be retrieved from one or more databases and displayed to the user. The user can then change the data by assigning a new value to certain data fields as specified by the user.

Typically, when changes are made to the data in a document or object (e.g. an HTML page), the data in associated databases must be updated to reflect those changes. One technique is to update the values of all data fields (i.e., whether or not the data has been changed) of the document in the databases, by overwriting the value of each data field as stored in the databases with the current value of the corresponding data field in the document or object. At any given time, the current value of a data field reflects the most recent changes made, if any, to the value of that data field. However, this technique can be inefficient, particularly for documents or objects comprising a large amount of data where the data of only a few data fields may have been changed by the user.

Other strategies for updating data in a database may be used, however, many of these other strategies require the identification of which specific data fields in the document or object have been changed.

U.S. Pat. No. 5,317,730 discloses a system and method for dynamically processing a list of data objects retrieved from a database. A “cut & paste filter” (“C&PF”) permits users to work with lists of data objects in an object-oriented computing system. The C&PF is capable of displaying lines of data on a screen and permitting changes to be made to the data without actually committing those changes to the database. Until the user commits the changes to the database, the lines of data displayed by the C&PF are considered to be “dirty” (i.e., modified).

The system and method described in U.S. Pat. No. 5,317,730 do not permit specific data fields which have had their values changed by a user to be marked as “dirty”. The system and method described in U.S. Pat. No. 5,317,730 also do not relate to the handling of “dirty” data in documents or objects comprising one or more levels of sub-documents or other objects, or data update techniques for such documents.

U.S. Pat. No. 5,768,511 discloses a system and method for managing objects in a networked client-server computing system. An application program creates and stores data in the form of objects in a database. When a window or panel in the client is to use an object stored in the database, a “partial” object comprising a number of selected attributes which contain data is created in the client. For each of these attributes, the object includes a “clean” field containing data as stored in the database, and a “dirty” field containing any changes to that data which have yet to be saved in the database. Data in the “dirty” field can be used to update the existing objects in the database.

The system and method described in U.S. Pat. No. 5,768,511 do not teach the creation of a record containing entries indicating only which data fields in a document are “dirty”, to be sent back to the server with the data to be saved in the database. The system and method described in U.S. Pat. No. 5,768,511 also define multiple fields for each attribute in the created “partial” object. This can be inefficient particularly for large objects having many attributes, and where the data of only a small number of those attributes have changed in value.

U.S. Pat. No. 5,864,849 discloses a system and method for restoring a multiple checkpointed database. A checkpoint is a copy of a database stored apart from the database itself. A “dirty page” table is associated with each checkpoint to keep track of records that have been changed or updated since the most recent update of the database.

The system and method described in U.S. Pat. No. 5,864,849 are directed towards the restoration of corrupted databases and do not relate to the updating of data in databases based on information obtained from a user through documents such as HTML pages. The system and method described in U.S. Pat. No. 5,864,849 also do not relate to the handling of “dirty” data in documents or objects comprising one or more levels of sub-documents or other objects, or data update techniques for such documents or objects.

U.S. Pat. No. 5,974,238 discloses a system and method for communicating data records between a desktop computer and a handheld computer, specifically data records relating to calendars, telephone directories, to-do lists, and the like. The system may also provide for a file viewer or browser to allow for the viewing of files of particular types of common applications including word processor, spreadsheet and database files. The system also provides for tags which are capable of indicating whether certain records are “dirty” (i.e. modified).

The system and method described in U.S. Pat. No. 5,974,238 do not permit specific data fields in a document which have had their values changed by a user to be marked as “dirty”. The system and method described in U.S. Pat. No. 5,974,238 also do not relate to the handling of “dirty” data in documents or objects comprising one or more levels of sub-documents or other objects, or data update techniques for such documents or objects.

Accordingly, there is a need for a system where specific data fields in a document which have had their values changed by a user can be marked as “dirty” to facilitate the updating of databases containing values for those data fields. There is also a need for system and method of handling “dirty” data in documents or objects comprising one or more levels of sub-documents or other objects.

### SUMMARY OF THE INVENTION

The present invention relates to a system and method for indicating when changes to values of data fields in a document have occurred.

One aspect of the present invention is a method of indicating when changes to values of data fields in a document have occurred, comprising the steps of storing in at least one first object initial values of the data fields in a document, initially storing in at least one second object the same values as stored in the first object and subsequently modifying the values in the at least one second object to reflect the most current values of the data fields in a document, comparing the values stored in the first and second objects to determine which data fields are “dirty”, creating records identifying the “dirty” data fields, and transmitting the records to a server for updating databases which store data for the data fields in the document.

Another aspect of the present invention relates to a system for indicating when changes to values of data fields in a document have occurred comprising at least one first object for storing the initial values of data fields in a document, at least one second object for storing the current values of those data fields, and a module for comparing the values in the first and second objects, for determining which data fields are “dirty”, and for creating records that indicate which data fields are “dirty”.

It will be appreciated by those skilled in the art that the invention can be embodied in a computer program which can be stored in storage or transmitted as a signal, such as on a modulated carrier signal for use in a computer system, or on a network such as the Internet.

### BRIEF DESCRIPTION OF THE DRAWINGS

For a better understanding of the present invention, and to show more clearly how it may be carried into effect, reference will now be made, by way of example, to the accompanying drawings which show a preferred embodiment of the present invention, and in which:

FIG. 1 is a schematic diagram illustrating the present invention; and

FIG. 2 is a flowchart illustrating the steps performed in the present invention.

### DETAILED DESCRIPTION OF THE PREFERRED EMBODIMENTS

In the claims and in the specification, a notebook is defined as a Graphical User Interface (GUI) object that allows information to be displayed using a set of one or more panels, where each panel contains related information. Each panel comprises multiple data fields. Values assigned to those data fields can be displayed and subsequently changed by a user by assigning a new value to the appropriate data fields. Since a notebook can comprise numerous such panels, the data in a notebook can be changed by a user by modifying the values of data fields in the notebook's various panels.

Furthermore, in the specification and in the claims, a data field is considered to be “dirty” if the data field has a current value which differs from its initial value. The initial value of a data field in a document or object is the value of the data field as stored in the databases at the time the document or object is opened or created. The current value of a data field in a document or object is the value of the data field in the document, reflecting the most recent changes made, if any, to the value of the data field by a user.

More generally, an object is considered to be “dirty” if the object consists of at least one “dirty” data field. By determining which data fields in a document or object have become “dirty”, different database update strategies may be used.

For example, some database update strategies for data in a notebook may include:

(i) Dirty field update:

only “dirty” fields in a notebook are updated

(ii) Dirty panel update:

only the “dirty” and non-“dirty” fields of “dirty” panels are updated

(iii) Dirty notebook update:

only the “dirty” and non-“dirty” fields of a “dirty” notebook are updated

(iv) Optimistic locking algorithm:

the non-“dirty” fields of a notebook are compared with their corresponding values in the databases and the “dirty” fields of the notebook are updated only if the compared values are the same; this algorithm may be used in multi-user environments to improve the integrity of data in databases

The present invention relates to a system and method for indicating when changes have been made by a user to the values of data fields in a document or object. Put another way, the system and method of the present invention allows for the identification of “dirty” data fields in a document or object. This permits different update strategies including those discussed above to be used in updating the databases in which data associated with the document or object is stored.

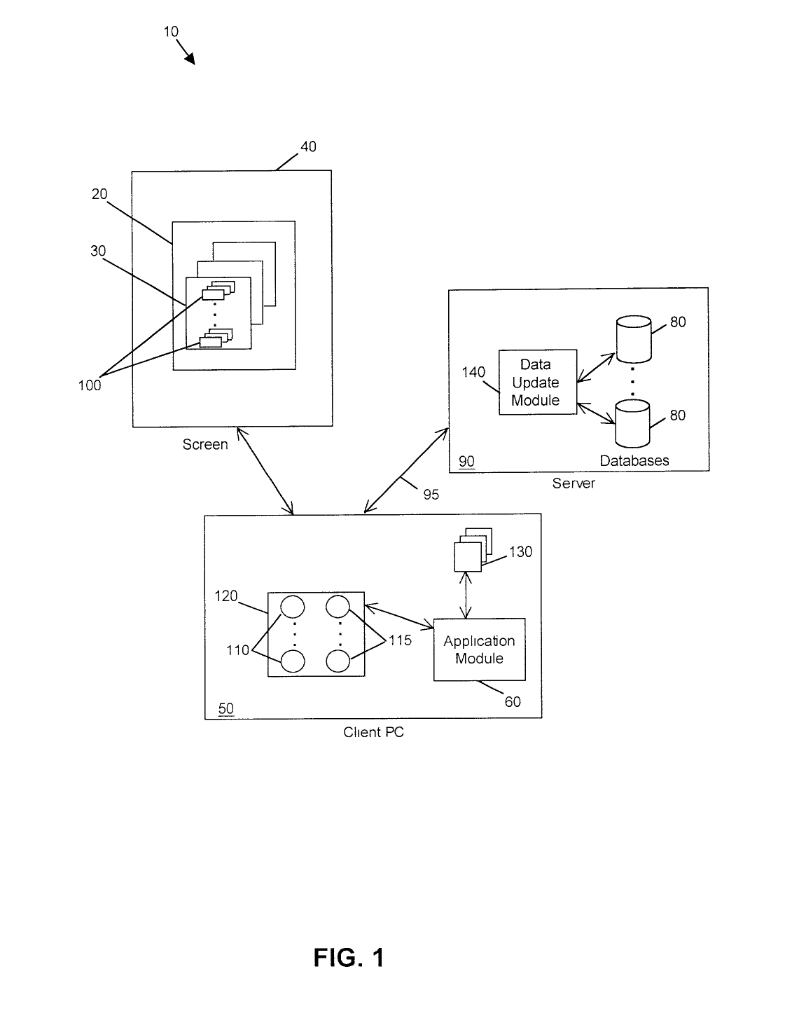

Referring to FIG. 1, a system for indicating when changes to values of data fields in a document have occurred is shown generally as 10. An instance of a notebook 20 containing one or more panels 30 is displayed on a user's screen 40 which is connected to a client personal computer (PC) 50. The panels 30 of the notebook instance 20 may be used to display data to a user as dictated by an application module 60 running on the client PC 50. However, the application module 60 need not reside on the client PC 50 and may be running on any other computing machine connected to the client PC 50.

As mentioned earlier in this specification, a notebook 20 is a GUI object that allows information to be displayed through one or more panels 30, where each panel 30 contains related information. A user can view the data in a panel 30 and switch between panels 30 by selecting a tab associated with each of the panels 30 or by another means as will be known to those skilled in the art. Typically, only one panel 30 is selected for display and editing of data at any one time.

The data to be displayed in the notebook instance 20 is stored in one or more databases 80 residing on a server 90 connected to the client PC 50 by a network connection 95. Each panel 30 of the notebook instance 20 contains multiple data fields 100. Each data field 100 can display a value and/or allow the user to change the value of the data field 100. The input fields may include text fields, check boxes, radio buttons, etc. For example, consider a notebook instance 20 identified as “contact” for displaying information about contacts. Assume the “contact” notebook contains three panels 30, the first panel identified as “general”, the second panel identified as “address”, and the third panel identified as “numbers”. Also assume that the “general” panel contains three data fields 100 identified as “name”, “age”, and “birthdate”, that the “address” panel contains five data fields 100 identified as “street”, “city”, “province”, “country”, and “postal code”, and that the “numbers” panel contains three data fields 100 identified as “workphone”, “homephone”, and “fax”.

The data associated with an instance of a notebook 20 might be the following, as represented in XML format:

<?xml version = “1.0” encoding = “iso-8859-1”?>
<contact>

<general>

<name>Gerry Kovan</name>
<age>28</age>
<birthdate>01/01/1972</birthdate>

</general>
<address>

<street>123 Anywhere Street</street>
<city>Toronto</city>
<province>Ontario</province>
<country>Canada</country>
<postalcode>M3C 1W3</postalcode>

</address>
<numbers>

<workphone>416-123-1234</workphone>
<homephone>416-999-0000</homephone>
<fax>416-123-0000</fax>

</numbers>

</contact>

Assume in this example, that a user opens this instance of a “contact” notebook 20 and changes the information associated with the following data fields 100: age, street, postalcode, workphone, and fax. The data fields 100 that have changed are considered to be “dirty”.

In accordance with the present invention, a first object 110 and a second object 115 are created by the application module 60 for each panel 30 associated with a notebook instance 20 at the time the notebook instance 20 is created. Each first object 110 and second object 115 created is stored in a memory or storage device 120. The memory or storage device 120 may be, more specifically, a disk, cache memory, conventional RAM or other memory or storage device as known.

The first object 110 associated with a specific panel 30 stores values corresponding to the initial state of the data associated with data fields 100 of the specific panel 30, upon the opening of the notebook instance 20 by the application module 60. The second object 115 associated with the specific panel 30 initially also stores values corresponding to the initial state of the data associated with data fields 100 of the specific panel 30, but is subsequently updated whenever changes are made to the data in the specific panel 30 by a user. The second object 115 associated with the specific panel 30 is used to retain the most current values of the data fields 100 in the specific panel 30, with the values in that second object 115 reflecting any changes made to the data associated with those data fields 100 in the specific panel 30.

In accordance with the present invention, one or more dirty data field records 130 created by the application module 60 comprise a list of data fields 100 identified as “dirty”. For example, the dirty data field records 130 may comprise a list of identifiers of data fields 100, each of which is assigned a boolean value of “true” to indicate whether the data field 100 identified is “dirty”. A data field 100 is considered “dirty” if the current value of the data field 100 differs from the initial value of the data field 100. This can be determined for each panel 30 in a notebook instance 20 by comparing the data associated with the data field 100 stored in the first object 110 and second object 115 for the specific panel 30.

When a user submits the data in a notebook instance 20 for processing, the application module 60 sends to the server 90 the dirty data field records 130 along with the data in the notebook instance 20. The dirty data field records 130 can then be used by a data update module 140 on the server 90 to update the data in the databases 80 with data received from the user through the panels 30 of the notebook instance 20.

According to the example provided above with respect to the “contact” notebook, the data sent to the server 90 when the data in that notebook instance 20 is submitted for processing can be represented in XML, incorporating the contents of the dirty data records 130 as follows:

<?xml version = “1.0” encoding = “iso-8859-1”?>
<contact>

<general>

<name>Gerry Kovan</name>
<age>30</age>
<birthdate>01/01/1972</birthdate>
<dirtyData>
<age>true</age>
</dirtyData>

</general>
<address>

```
<street>789 Anyplace Road</street>
<city>Toronto</city>
<province>Ontario</province>
<country>Canada</country>
<postalcode>M2C 1X3</postalcode>
<dirtyData>
    <street>true</street>
    <postalcode>true</postalcode>
</dirtyData>
```

</address>
<numbers>

```
<workphone>416-123-4444</workphone>
<homephone>416-999-0000</homephone>
<fax>416-555-0000</fax>
<dirtyData>
    <workphone>true</workphone>
    <fax>true</fax>
</dirtyData>
```

</numbers>

</contact>

The present invention thus permits the data update module 140 and other application modules to determine whether data received from a user has been changed by that user at different levels, for instance:

| | |
|---|---|
| (i) | at the field level: is a field dirty? |
| (ii) | at the panel level: does a panel contain at least one field that is |
| | dirty? |
| (iii) | at the notebook level: does a notebook contain at least one panel |
| | that is dirty |

This facilitates the use of many different database update strategies to be applied by a data update module 140 or other application modules in updating data in databases 80.

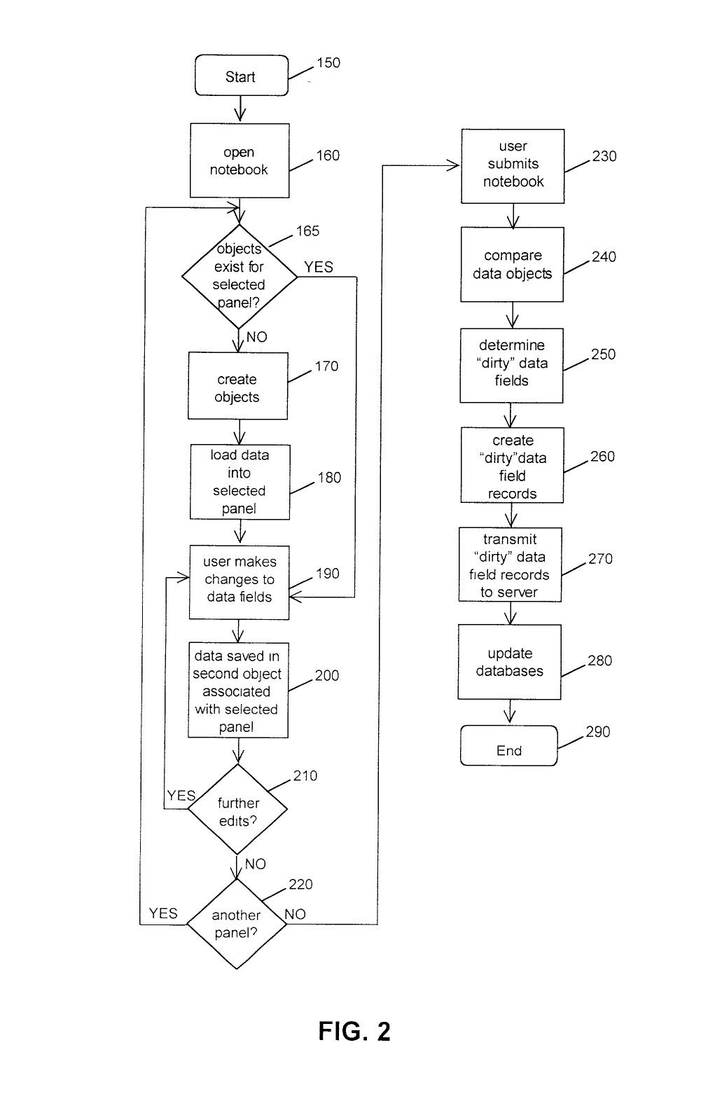

Referring to FIG. 2, a method of indicating when changes to values of data fields in a document have occurred is shown as a series of steps commencing at step 150.

At step 160, a user requests that an instance of a notebook 20 be opened. The data associated with the notebook instance 20 is then displayed on a screen 40. The notebook instance 20 is created by an application module 60, which in the preferred embodiment, resides on a client PC 50. Application module 60 initially selects a panel 30 to be the currently selected panel for display on the screen 40.

At step 165, application module 60 determines whether a first object 100 and a second object already exist for the currently selected panel. If so, the flow of method steps proceeds to step 190, otherwise the flow of method steps proceeds to step 170.

At step 170, application module 60 creates a first object 110 and a second object 1 15 for the currently selected panel 30 in the notebook instance 20, and retrieves data associated with the data fields 100 on the currently selected panel 30 from databases 80 located on a server 90. The values of the data fields 100 as retrieved from the databases 80 are stored in both the first object 100 and the second object 115 for the selected panel 30. These values represent the initial values of the data fields 100 of the selected panel 30.

At step 180, application module 60 loads the currently selected panel 30 with data in the corresponding first object 110.

At step 190, optionally, a user changes the value of a user-specified data field 100 in the currently selected panel 30 to a new value. The current value of the user-specified data field 100 is thus equal to this new value.

At step 200, the data in the second object 115 associated with the currently selected panel 30 is modified to reflect the change in the value of the user-specified data field 100. This can be done by overwriting the old value of the data field 100 as stored in the second object 115 with the new value.

As indicated at step 210, if further edits are to be made to the data in the currently selected panel 30, the flow of method steps proceeds back to step 190 where such changes can be made. Otherwise, the flow of method steps proceeds to step 220.

At step 220, a user may optionally select another panel 30 to view by selecting a tab associated with the other desired panel 30 (or by other selection means as known). If a user selects a different panel 30, the flow of method steps proceeds back to step 165, and the selected panel 30 becomes the currently selected panel 30. Otherwise, the flow of method steps proceeds to step 230 at which data in the notebook instance 20 is submitted by the user for processing.

At step 240, the application module 60 compares the data values of each of the data fields 100 in each panel 30 as stored in the first object 110 and the second object 115 of each panel 30.

At step 250, the application module 60 determines which data fields 100 are “dirty” for each panel 30; that is, the application module 60 determines which data fields 100 have a current value (as stored in the second object 115) that is not equal to its initial value (as stored in the first object 110) for each panel 30.

At step 260, the application module 60 creates a set of dirty data field records 130 that identify which data fields 100 are “dirty” as determined at step 250.

At step 270, the application module 60 transmits to the server 90 the dirty data field records 130 identifying data fields 100 for each panel 30 that are “dirty”, along with current values of the data fields 100 for each panel 30 as stored in the second object 115 of each panel 30.

Depending on the specific data update strategy used, it may be necessary to only transmit the current values of “dirty” data fields to the server 90 at step 270.

Preferably, only “dirty” data fields are identified in the dirty data field records 130 so that step 270 may be performed more efficiently, particularly when the number of data fields 100 in a notebook instance 20 is large.

At step 280, the dirty data field records 130 may be used by a data update module 140 to update the databases 80 with the data as submitted by the user through the panels 30 of the notebook instance 20.

Step 290 marks the end of the method of indicating when changes to values of data fields in a document have occurred.

In variant embodiments of the invention, first objects 110 and second objects 115 for all panels 30 of the notebook instance 20 can be created in the same method step after the notebook instance 20 is opened. Furthermore, in variant embodiments of the invention, all panels 30 of the notebook instance 20 may be loaded with data (e.g. from the second object 115 of each of the respective panels) in the same method step after the first objects 110 and second objects 115 for the panels 30 of the notebook instance 20 have been created and initialized with data from the databases 80.

The present invention may be particularly useful in Internet applications. The present invention may be used in a web-based notebook implementation. By providing a means to track whether data fields of a document or object are “dirty”, different data update strategies may be implemented. In particular, data update strategies geared towards maintaining data integrity in multi-user environments may also be implemented using the present invention.

In a variant embodiment of the invention, in a web-based implementation of the invention, a Hypertext Markup Language (HTML) page containing an HTML form may be used to accept input from the user. The data to be displayed in the HTML form is stored in one or more databases residing on a server. The HTML form can contain multiple data fields, each of which can display a value and/or allow the user to change the value of the data field. For example, an HTML form may contain data fields relating to the following:

| | |
|---|---|
| (i) | a name, which can be represented in a text field; |
| (ii) | an age range, which can be represented using radio buttons (e.g. a |
| | button for each age group: age 10-18, age 19-35, age 36+, etc.); |
| | and |
| (iii) | an email notification switch, which can be represented by a |
| | checkbox indicating whether or not the user is to receive e-mail |
| | messages. |

In accordance with the present invention, as applied to this variant embodiment, the HTML document must also define and create objects that reflect the information in the HTML form. This object can be defined and created using an application module for executing scripts coded in browser-based scripting languages such as Javascript or Visual Basic Script, for example. An example of a JavaScript definition of such an object for the HTML form may be:

<SCRIPT>
function (name, age, emailNotify)
{

this.name = name;
this.age = age;
this.emailNotify = emailNotify;

}
</SCRIPT>

Two such objects are created in accordance with the present invention. As in the preferred embodiment of the invention, the objects are used to create dirty data records for updating the data in associated databases. Essentially, this variant embodiment of the invention is a special case of the preferred embodiment, if the notebook instance 20 of the preferred embodiment only contains one panel 30. In this variant embodiment of the invention, the HTML page replaces the notebook instance 20, and the HTML form replaces the single panel 30. Minor modifications to the system may be made to provide hardware or any other requirements necessary for this web-based implementation of the invention. The method of the present invention may also be similarly applied to this variant embodiment.

In the specification and in the claims, a document is any object capable of presenting data and accepting data as input, or any object that comprises objects capable of presenting data and accepting data as input. This includes HTML pages, notebooks, or objects containing one or more instances of these documents/objects, for example.

With respect to the elements of the system 10 described in this specification, it will be apparent to those skilled in the art that the execution of various tasks need not be performed by the particular component specified in the description of the preferred embodiment of the invention. It will also be apparent to those skilled in the art that components of the systems 10 need not reside on a specific computing machine or device as described in the specification, and need not be implemented in the specific manner as described in the specification. For example, the components of the system 10 may physically reside on a single computing device, or may be distributed across multiple computing devices. Data stored in databases may be stored in a single database, or distributed across several databases or other storage means. The connections (e.g. 95) of system 10 can be maintained by any data communication means as is known, including a Ethernet network connection, a TCP/IP connection, wireless communication means, or other known connection means. The tasks performed by application module 60 or data update module 140 maybe performed by multiple modules, or a module different than that suggested in the specification according to the preferred embodiment of the invention.

As will be apparent to those skilled in the art, other variations, modifications and adaptations of the systems and methods described herein are possible without departing from the present invention, the scope of which is defined in the claims.

The embodiments of the invention in which an exclusive property or privilege is claimed are defined as follows:

1. A method of indicating when changes to values of data fields in a document have occurred, said method comprising the steps of:

| | |
|---|---|
| (a) | storing a first plurality of values in at least one first object, said first |
| | plurality of values comprising initial values of a plurality of data |
| | fields in a document; |
| (b) | storing a second plurality of values in at least one second object, |
| | said second plurality of values being identical to said first plurality |
| | of values; |
| (c) | receiving modifications from a user to said data fields and storing |
| | said modifications in said at least one second object as current |
| | values; |
| (d) | comparing said first and second plurality of values to determine |
| | which data fields have initial values different from their current |
| | values; |
| (e) | creating a plurality of records identifying all data fields having |
| | initial values different from their current values as determined in |
| | step (d); and |
| (f) | transmitting said plurality of records to a server, said plurality of |
| | records for use in updating data in a data storage device. |

2. The method as claimed in claim 1, wherein said document is an HTML document containing an HTML form.

3. The method as claimed in claim 2, wherein step (a) is performed when said HTML form is loaded into a web browser.

4. The method as claimed in claim 3, wherein step (d) is performed after said modifications have been completed by said user.

5. The method as claimed in claim 4, wherein said plurality of records comprise a plurality of data field identifiers, and wherein each of said data field identifiers identifies one of said plurality of data fields in said document.

6. The method as claimed in claim 5, wherein said plurality of records further comprise a boolean value assigned to each of said data field identifiers to indicate whether said data field has an initial value different from its current value as determined in step (d).

7. The method as claimed in claim 1, wherein said document comprises a notebook.

8. The method as claimed in claim 7, wherein said notebook comprises at least one panel.

9. The method as claimed in claim 8, wherein step (a) is performed when said notebook is opened.

10. The method as claimed in claim 9, wherein step (d) is performed on data in a panel of said at least one panel after said modifications have been completed by said user.

11. The method as claimed in claim 10, wherein step (e) is performed for said panel of said at least one panel, wherein said plurality of records created comprise a plurality of data field identifiers, and wherein each of said data field identifiers identifies one of said plurality of data fields in said panel.

12. The method as claimed in claim 11, wherein said plurality of records further comprise a boolean value assigned to each of said data field identifiers to indicate whether said data field has an initial value different from its current value as determined in step (d).

13. The method as claimed in claim 12, wherein steps (d), (e) and (f) are repeated for each panel in a notebook.

14. The method as claimed in claim 13, wherein said plurality of records are used to determine at least one of the following:

| | |
|---|---|
| (i) | whether a data field has an initial value different from its current |
| | value; |
| (ii) | whether a panel comprises a data field having an initial value |
| | different from its current value; and |
| (iii) | whether said notebook comprises a panel which comprises a data |
| | field having an initial value different from its current value. |

15. The method as claimed in claim 1, wherein said document comprises a hierarchy of documents, and wherein said plurality of records are used to determine whether a data field having an initial value different from its current value exists at a specified level of said hierarchy of documents.

16. A system for indicating when changes to values of data fields in a document have occurred, said system comprising:

| | |
|---|---|
| (a) | at least one first object for storing a first plurality of values, said |
| | first plurality of values comprising initial values of a plurality of |
| | data fields in a document; |
| (b) | at least one second object for storing a second plurality of values, |
| | said second plurality of values comprising current values of said |
| | plurality of data fields in said document; and |
| (c) | a module connected to said at least one first and said at least one |
| | second objects for comparing said first and second plurality of |
| | values, for determining which data fields have initial values |
| | different from their current values, and for creating a plurality of |
| | records identifying all data fields having initial values different |
| | from their current values. |

17. The system as claimed in claim 16, wherein said document is an HTML document containing an HTML form.

18. The system as claimed in claim 17, wherein said plurality of records comprise a plurality of data field identifiers, and wherein each of said data field identifiers identifies one of said plurality of data fields in said document.

19. The system as claimed in claim 18, wherein said plurality of records further comprise a boolean value assigned to each of said data field identifiers to indicate whether said data field has an initial value different from its current value.

20. The system as claimed in claim 16, wherein said document is comprises a notebook.

21. The system as claimed in claim 20, wherein said notebook comprises at least one panel.

22. The system as claimed in claim 21, wherein said plurality of records created comprise a plurality of data field identifiers, and wherein each of said data field identifiers identifies one of said plurality of data fields in said panel.

23. The system as claimed in claim 22, wherein said plurality of records further comprise a boolean value assigned to each of said data field identifiers to indicate whether said data field has an initial value different from its current value.

24. The system as claimed in claim 23, wherein said plurality of records are used to determine at least one of the following:

| | |
|---|---|
| (i) | whether a data field has an initial value different from its current |
| | value; |
| (ii) | whether a panel comprises a data field having an initial value |
| | different from its current value; and |
| (iii) | whether said notebook comprises a panel which comprises a data |
| | field having an initial value different from its current value. |

25. The system as claimed in claim 16, wherein said document comprises a hierarchy of documents, and wherein said plurality of records are used to determine whether a data field having an initial value different from its current value exists at a specified level of said hierarchy of documents.

26. A computer-readable medium having stored thereon computer-executable instructions for indicating when changes to values of data fields in a document have occurred by performing the steps comprising:

| | |
|---|---|
| (a) | storing a first plurality of values in at least one first object, said |
| | first plurality of values comprising initial values of a plurality of |
| | data fields in a document; |
| (b) | storing a second plurality of values in at least one second object, |
| | said second plurality of values being identical to said first plurality |
| | of values; |
| (c) | receiving modifications from a user to said data fields and storing |
| | said modifications in said at least one second object as current |
| | values; |
| (d) | comparing said first and second plurality of values to determine |
| | which data fields have initial values different from their current |
| | values; |
| (e) | creating a plurality of records identifying all data fields having |
| | initial values different from their current values as determined in |
| | step (d); and |
| (f) | transmitting said plurality of records to a server, said plurality of |
| | records for use in updating data in a data storage device. |

27. The computer-readable medium as claimed in claim 26, wherein said document is an HTML document containing an HTML form.

28. The computer-readable medium as claimed in claim 27, wherein step (a) is performed when said HTML form is loaded into a web browser.

29. The computer-readable medium as claimed in claim 28, wherein step (d) is performed after said modifications have been completed by said user.

30. The computer-readable medium as claimed in claim 29, wherein said plurality of records comprise a plurality of data field identifiers, and wherein each of said data field identifiers identifies one of said plurality of data fields in said document.

31. The computer-readable medium as claimed in claim 30, wherein said plurality of records further comprise a boolean value assigned to each of said data field identifiers to indicate whether said data field has an initial value different from its current value as determined in step (d).

32. The computer-readable medium as claimed in claim 26, wherein said document comprises a notebook.

33. The computer-readable medium as claimed in claim 32, wherein said notebook comprises at least one panel.

34. The computer-readable medium as claimed in claim 33, wherein step (a) is performed when said notebook is opened.

35. The computer-readable medium as claimed in claim 34, wherein step (d) is performed on data in a panel of said at least one panel after said modifications have been completed by said user.

36. The computer-readable medium as claimed in claim 35, wherein step (e) is performed for said panel of said at least one panel, wherein said plurality of records created comprise a plurality of data field identifiers, and wherein each of said data field identifiers identifies one of said plurality of data fields in said panel.

37. The computer-readable medium as claimed in claim 36, wherein said plurality of records further comprise a boolean value assigned to each of said data field identifiers to indicate whether said data field has an initial value different from its current value as determined in step (d).

38. The computer-readable medium as claimed in claim 37, wherein steps (d), (e) and (f) are repeated for each panel in a notebook.

39. The computer-readable medium as claimed in claim 38, wherein said plurality of records are used to determine at least one of the following:

| | |
|---|---|
| (i) | whether a data field has an initial value different from its current |
| | value; |
| (ii) | whether a panel comprises a data field having an initial value |
| | different from its current value; and |
| (iii) | whether said notebook comprises a panel which comprises a data |
| | field having an initial value different from its current value. |

40. The computer-readable medium as claimed in claim 26, wherein said document comprises a hierarchy of documents, and wherein said plurality of records are used to determine whether a data field having an initial value different from its current value exists at a specified level of said hierarchy of documents.

41. A software product for indicating when changes to values of data fields in a document have occurred, said software product comprising:

| | |
|---|---|
| (a) | at least one first object for storing a first plurality of values, said |
| | first plurality of values comprising initial values of a plurality of |
| | data fields in a document; |
| (b) | at least one second object for storing a second plurality of values, |
| | said second plurality of values comprising current values of said |
| | plurality of data fields in said document; and |
| (c) | a module connected to said at least one first and said at least one |
| | second objects for comparing said first and second plurality of |
| | values, for determining which data fields have initial values |
| | different from their current values, and for creating a plurality of |
| | records identifying all data fields having initial values different |
| | from their current values. |

42. The software product as claimed in claim 41, wherein said document is an HTML document containing an HTML form.

43. The software product as claimed in claim 42, wherein said plurality of records comprise a plurality of data field identifiers, and wherein each of said data field identifiers identifies one of said plurality of data fields in said document.

44. The software product as claimed in claim 43, wherein said plurality of records further comprise a boolean value assigned to each of said data field identifiers to indicate whether said data field has an initial value different from its current value.

45. The software product as claimed in claim 41, wherein said document is comprises a notebook.

46. The software product as claimed in claim 45, wherein said notebook comprises at least one panel.

47. The software product as claimed in claim 46, wherein said plurality of records created comprise a plurality of data field identifiers, and wherein each of said data field identifiers identifies one of said plurality of data fields in said panel.

48. The software product as claimed in claim 47, wherein said plurality of records further comprise a boolean value assigned to each of said data field identifiers to indicate whether said data field has an initial value different from its current value.

49. The software product as claimed in claim 48, wherein said plurality of records are used to determine at least one of the following:

| | |
|---|---|
| (i) | whether a data field has an initial value different from its current |
| | value; |
| (ii) | whether a panel comprises a data field having an initial value |
| | different from its current value; and |
| (iii) | whether said notebook comprises a panel which comprises a data |
| | field having an initial value different from its current value. |

50. The software product as claimed in claim 41, wherein said document comprises a hierarchy of documents, and wherein said plurality of records are used to determine whether a data field having an initial value different from its current value exists at a specified level of said hierarchy of documents.

51. A computer program comprising computer program code means adapted to perform all the steps of claim 1 when said program is run on a computer.

52. A computer program as claimed in claim 51 embodied on a computer readable medium.

53. A computer program product comprising:
a computer-readable signal-bearing medium;
means in said medium for accomplishing the method of any of claims 1 to 15.

54. The product of claim 45, wherein said medium is a recordable data storage medium.

55. The product of claim 53 wherein said medium is a modulated carrier signal.

56. The product of claim 55 wherein said signal is a transmission over a network.

57. The product of claim 56 wherein said network is the Internet.
